(19) United States
(12) Patent Application Publication
(10) Pub. No.: US 2025/0325137 A1
(43) Pub. Date: Oct. 23, 2025

(54) Beverage Preparation Machine

(71) Applicant: Huiling-Tech Robotic Co., Ltd., Baoan Dist. Shenzhen, Guangdong (CN)

(72) Inventors: Jun Tian, Baoan Dist. Shenzhen, Guangdong (CN); Yue Hu, Baoan Dist. Shenzhen, Guangdong (CN); Lichun Zou, Baoan Dist. Shenzhen, Guangdong (CN); Jiaji Yin, Baoan Dist. Shenzhen, Guangdong (CN); Hao Chen, Baoan Dist. Shenzhen, Guangdong (CN); Zuocai Hu, Baoan Dist. Shenzhen, Guangdong (KY); Xianqing Ceng, Baoan Dist. Shenzhen, Guangdong (CN)

(21) Appl. No.: 18/992,273

(22) PCT Filed: Jun. 9, 2023
(86) PCT No.: PCT/CN2023/099410

§ 371 Date: Jul. 3, 2025

(30) Foreign Application Priority Data
Jul. 9, 2022 (CN) 202210803731.4

(51) Int. Cl. A47J 31/41; A47J 31/44

(52) U.S. Cl. CPC A47J 31/41; A47J 31/4403

(57) ABSTRACT

A beverage preparation machine is provided, relating to the technical field of beverage preparation equipment. In the beverage preparation machine according to the embodiments of the present disclosure, multiple ingredient containers are arranged to fit with the conveyance device, beverage materials of a single taste are conveyed separately and then are prepared into a beverage, whereby the materials in each ingredient container will not be mixed and contaminated, and beverages can be prepared continuously without cleaning the pipeline while the tastes of the beverages are guaranteed. The beverage preparation machine has a high efficiency of beverage preparation and achieves a good use effect.

### TECHNICAL FIELD

The present disclosure relates to the technical field of beverage preparation equipment, more particularly to a beverage preparation machine.

### BACKGROUND

Concocted beverages are widely loved by consumers due to their excellent tastes, and there is a constantly increasing demand for concocted beverages in the market too. Existing concocted beverages generally need to be prepared by human. When there is large order quantity, the demand for cup delivery generally cannot be satisfied. At present, beverage auto preparation equipment begins to appear in the market, which is mainly to dilute the beverage materials inside a material storage box therein to achieve the beverage preparation function.

However, the existing beverage preparation equipment has the following problems. Multiple materials are conveyed through one conveyance pipeline, which results in a mixed taste of beverages and thus cannot guarantee the tastes of the beverages. In order to guarantee the tastes of the beverages, it is needed to clean the pipeline after each time of preparation, which greatly impacts the efficiency of beverage preparation.

Therefore, improvements need to be made in view of the above problems to change the existing situation.

### SUMMARY

The present disclosure provides a beverage preparation machine to solve the problems of the existing beverage preparation equipment that ingredients are prone to mixing and tastes of beverages cannot be guaranteed.

The present disclosure provides a beverage preparation machine, including:
a frame structure including an accommodation cavity formed therein;
an ingredient device including a plurality of ingredient containers configured to store respectively materials for preparing beverages, the ingredient device being housed inside the accommodation cavity;
a conveyance device connected to the plurality of ingredient containers respectively and configured to convey the materials; and
a discharge device including a discharge bracket and a discharge assembly. The discharge assembly includes a plurality of discharge nozzles, and the discharge bracket has one end connected to the frame structure and projects outward from the frame structure. The discharge nozzles are connected to another end of the discharge bracket and the discharge nozzles are connected to the conveyance device by means of a beverage pipeline. The beverage pipeline is housed inside the discharge bracket.

According to one embodiment of the present disclosure, the discharge assembly further includes a discharge installation bracket and a discharge fixing element. The discharge installation bracket is connected to one end of the discharge bracket away from the frame structure, and the discharge fixing element is detachably connected to the discharge installation bracket and forms a discharge cavity with the discharge installation bracket. The discharge nozzles are detachably connected to discharge installation bracket and are housed inside the discharge cavity. The discharge fixing element is further formed with a plurality of discharge holes communicated with the plurality of discharge nozzles respectively.

According to one embodiment of the present disclosure, the discharge assembly further includes a discharge one-way valve housed inside the discharge cavity. The discharge one-way valve is connected to the discharge nozzle and the discharge hole respectively. The discharge one-way valve is configured to convey a beverage along the direction from the discharge nozzle toward the discharge hole.

According to one embodiment of the present disclosure, the beverage preparation machine further includes a control device, the control device including an interaction component and a control module. The control module is connected to the interaction component, the ingredient device and the conveyance device by means of signals. The interaction component is moveably connected to the discharge bracket, and the position of the interaction component is adjustable relative to the discharge bracket. The interaction component includes at least one of a display-touch integrated screen and a scanner.

According to one embodiment of the present disclosure, the discharge device further includes an adjustment structure. The adjustment structure includes an adjustment fixing bracket and an adjustment bracket. The discharge bracket has an outer wall formed with an adjustment groove. The adjustment fixing bracket is arranged inside the discharge bracket and is connected to the discharge bracket. The adjustment bracket is connected to the adjustment fixing bracket and is adjustable relative to the adjustment fixing bracket. The adjustment bracket projects at least in part out of the discharge bracket from the adjustment groove. The interaction component is connected to the adjustment bracket and positioned outside the discharge bracket.

According to one embodiment of the present disclosure, the control device further includes a precise scale arranged on the frame structure. The precise scale is connected to the control module by means of a signal.

According to one embodiment of the present disclosure, the beverage preparation machine further includes a liquid receiving assembly arranged below the discharge nozzle. The liquid receiving assembly includes a liquid receiving cavity, a liquid discharge pipe and a liquid receiving plate. The liquid receiving plate covers an opening of the liquid receiving cavity. The liquid discharge pipe is connected to the liquid receiving cavity and is positioned at least in part at a bottom of the liquid receiving cavity. The liquid receiving plate is configured to bear a beverage container and the liquid receiving plate is formed with at least one liquid receiving hole therethrough. An orthographic projection of the beverage container on the liquid receiving plate is overlapped at least in part with the liquid receiving hole.

According to one embodiment of the present disclosure, the liquid receiving assembly further includes a liquid receiving seat detachably connected to the liquid receiving plate. The liquid receiving seat has formed therein a funnel shaped liquid outlet hole communicated with the liquid receiving cavity.

According to one embodiment of the present disclosure, the liquid receiving assembly further includes a liquid guide plate. One end of the liquid guide plate is connected to an inner wall of the liquid receiving cavity while another end thereof is inclined downward; and/or the liquid receiving assembly further includes a positioning projection part. The positioning projection part is arranged on the inner wall of the liquid receiving cavity in a projecting manner and is configured to abut against a bottom of the liquid receiving plate.

According to one embodiment of the present disclosure, the opening of the liquid receiving cavity is formed on a top surface of the frame structure. A top of the frame structure is further provided with a flange part. The flange part is arranged on the top surface and is positioned on at least one side edge of the top surface.

According to one embodiment of the present disclosure, the discharge bracket is connected to the frame structure and projects outward from the frame structure. The discharge assembly is connected to one end of the discharge bracket away from the frame structure. The discharge bracket penetrates through an external wall. The frame structure and the discharge assembly are positioned on two opposite sides of the wall respectively.

According to one embodiment of the present disclosure, the frame structure includes a cabinet body, a cabinet door and a separation plate. The cabinet door is moveably connected to the cabinet body to form an accommodation cavity. The separation plate is arranged inside the accommodation cavity and separates the accommodation cavity into a first cavity and a second cavity. The ingredient container includes a material barrel, a syrup barrel and a drinking water tank. The material barrel is housed inside the first cavity. The frame structure further includes a refrigeration component. The refrigeration component is configured to refrigerate the first cavity. The syrup barrel and the drinking water tank are arranged inside the second cavity, and the drinking water tank is connected to the conveyance device through a pipeline

The embodiments of the present disclosure have the following beneficial effects.

In the beverage preparation machine according to the embodiments of the present disclosure, multiple ingredient containers are arranged to fit with the conveyance device, beverage materials of a single taste are conveyed separately and then are prepared into a beverage, whereby the materials in each ingredient container will not be mixed and contaminated, and beverages can be prepared continuously without cleaning the pipeline while the tastes of the beverages are guaranteed. The beverage preparation machine has a high efficiency of beverage preparation and achieves a good use effect.

### BRIEF DESCRIPTION OF THE DRAWINGS

For a better understanding of the technical scheme in the embodiments of the present disclosure or in the prior art, accompanying drawings required to be used in the description of the embodiments or the prior art are simply illustrated below. Apparently, the accompanying drawings described below are some embodiments of the present disclosure merely. For the ordinary skill in the field, other accompanying drawings may be obtained without creative effort according to these accompanying drawings.

The accompanying drawings are described as below.

FIG. 1 is a perspective view of an internal structure of a beverage preparation machine according to an embodiment of the present disclosure.

FIG. 2 is a perspective view of a rear internal structure of a beverage preparation machine according to an embodiment of the present disclosure.

FIG. 3 is an exploded view of a partial structure of a beverage preparation machine according to an embodiment of the present disclosure.

FIG. 4 is a side view of a discharge device according to an embodiment of the present disclosure.

FIG. 5 is a sectional view taken along line A-A of FIG. 4.

FIG. 6 is a perspective view of a beverage preparation machine according to another embodiment of the present disclosure.

FIG. 7 is a structure diagram of an ingredient device according to an embodiment of the present disclosure.

FIG. 8 is a sectional view of a material barrel according to an embodiment of the present disclosure.

FIG. 9 is a perspective view of a beverage preparation machine according to an embodiment of the present disclosure, from one angle of view.

FIG. 10 is an enlargement view of part B in FIG. 9.

FIG. 11 is a separation state of a discharge device and a cleaning flow-guide shade according to an embodiment of the present disclosure.

Reference numerals in the drawings are illustrated as below.

10, beverage preparation machine; 100, frame structure; 111, liquid receiving cavity; 112, liquid discharge pipe; 113, liquid receiving plate; 1131, liquid receiving hole; 114, liquid receiving seat; 115, positioning projection part; 116, liquid guide plate; 120, cabinet body; 1211, first cavity; 1212, second cavity; 122, flange part; 130, cabinet door; 140, separation plate; 150, refrigeration component; 151, condenser; 152, refrigerating machine; 153, filter fan; 154, cooling fan; 160, caster; 200, discharge device; 210, discharge bracket; 211, adjustment groove; 212, connection part; 220, discharge assembly; 221, discharge nozzle; 222, discharge one-way valve; 223, discharge installation bracket; 2231, discharge installation hole; 224, discharge fixing element; 2241, discharge hole; 231, adjustment fixing bracket; 232, adjustment bracket; 300, ingredient device; 310, ingredient container; 311, material barrel; 311-1, barrel body; 311-11, load-bearing part; 311-111, material storage cavity; 311-112, liquid storage position; 311-12, connection part; 311-13, support part; 311-131, reinforcement rib; 311-2, barrel cover; 311-21, cover main body; 311-211, material feeding hole; 311-212, liquid receiving groove; 311-213, connection hole; 311-22, moveable cover body; 311-23, extension part; 311-3, bearing board; 311-31, positioning groove; 312, syrup barrel; 320, drinking water tank; 330, weighing assembly; 400, conveyance device; 410, liquid pump; 420, solenoid valve; 500, cleaning device; 510, cleaning flow-guide shade; 511, fixing groove part; 512, connection groove part; 520, cleaning interface; 530, cleaning pump; 531, first cleaning pump; 532, second cleaning pump; 533, third cleaning pump; 610, interaction component; 611, display-touch integrated screen; 612, scanner; 620, precise scale; 20, beverage cup; and 30, wall.

### DETAILED DESCRIPTION OF THE EMBODIMENTS

The purpose, the technical scheme and the advantages of the present disclosure will become more clearly understood from the clear and complete description of the technical scheme of the present disclosure below taken in conjunction with the accompanying drawings in the present disclosure. Apparently, the embodiments described hereinafter are simply part embodiments of the present disclosure, rather than all of the embodiments. All other embodiments obtained by those ordinary skill in the art based on the embodiments of the present disclosure without creative work are intended to be included in the scope of protection of the present disclosure.

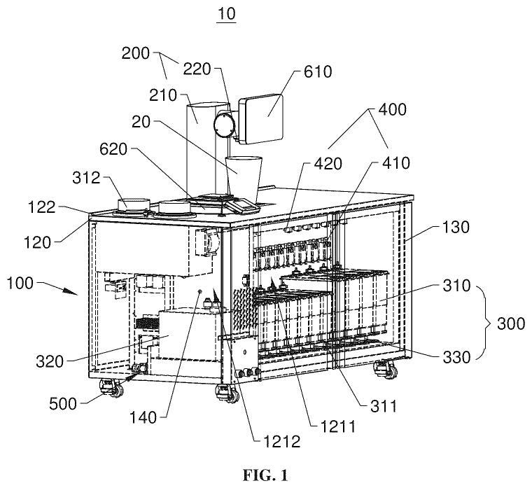

Referring to FIG. 1 to FIG, 11, an embodiment of the present disclosure provides a beverage preparation machine 10, including a frame structure 100, a discharge device 200, an ingredient device 300 and a conveyance device 400. The frame structure 100 includes an accommodation cavity formed therein. The ingredient device 300 includes a plurality of ingredient containers 310 configured to store respectively materials for preparing beverages. The ingredient device 300 is housed inside the accommodation cavity. The conveyance device 400 is connected to the plurality of ingredient containers 310 respectively and is configured to convey materials. The discharge device 200 includes a discharge bracket 210 and a discharge assembly 220. The discharge assembly 220 includes a plurality of discharge nozzles 221. The discharge bracket 210 has one end connected to the frame structure 100 and projects outward from the frame structure 100. The discharge nozzles 221 are connected to another end of the discharge bracket 210, and the discharge nozzles 221 are connected to the conveyance device 400 by means of a beverage pipeline. The beverage pipeline is housed inside the discharge bracket 210.

In the beverage preparation machine 10 of the present embodiment, multiple ingredient containers 310 are arranged to fit with the conveyance device 400, beverage materials of a single taste are conveyed separately and then are prepared into a beverage, whereby the materials in each ingredient container 310 will not be mixed and contaminated, and beverages can be prepared continuously without cleaning the pipeline while the tastes of the beverages are guaranteed. The beverage preparation machine has a high efficiency of beverage preparation and achieves a good use effect. When using the beverage preparation machine 10 of the present embodiment, a beverage cup 20 can be placed below the discharge nozzle 221 of the discharge device 200 to receive the beverage output from the discharge device 200.

In particular, referring to FIG. 5, the discharge assembly 220 further includes a discharge installation bracket 223 and a discharge fixing element 224. The discharge installation bracket 223 is connected to one end of the discharge bracket 210 away from the frame structure 100. The discharge fixing element 224 is detachably connected to the discharge installation bracket 223 and forms a discharge cavity with the discharge installation bracket 223. The discharge nozzles 221 are detachably connected to discharge installation bracket 223 and are housed inside the discharge cavity. The discharge fixing element 224 is further formed with a plurality of discharge holes 2241 communicated with the plurality of discharge nozzles 221 respectively.

With the above arrangement, the discharge nozzles 221 can be housed inside the discharge cavity enclosed by the discharge installation bracket 223 and the discharge fixing element 224, whereby being protected against dust and collision. When to detach and replace the discharge nozzles 221, it is only needed to separate the discharge fixing element 224 from the discharge installation bracket 223 to expose the discharge cavity and the discharge nozzles 221. Therefore, the discharge nozzles 221 are convenient to detach and maintain.

In one embodiment, the discharge nozzles 221 are connected to the conveyance device 400 by means of a hose. The discharge installation bracket 223 is formed with multiple discharge installation holes 2231. The discharge nozzles 221 are detachably connected into the discharge installation holes 2231 and are fixed by means of the discharge installation bracket 223, whereby being prevented from shaking.

Further, the discharge assembly 220 further includes a discharge one-way valve 222 housed inside the discharge cavity. The discharge one-way valve 222 is connected to the discharge nozzle 221 and the discharge hole 2241 respectively. The discharge one-way valve 222 is configured to convey a beverage along the direction from the discharge nozzle 221 toward the discharge hole 2241.

In the present embodiment, by arranging the discharge one-way valve 222 in an output direction of the discharge nozzle 221, the liquid output direction of the discharge nozzle 221 can be limited, whereby preventing a beverage from backflow. In this way, when to prepare two beverages of different tastes or types consecutively, it is not needed to clean the discharge device 200, meanwhile taste contamination can be avoided and the operation is of high efficiency.

In particular, the beverage preparation machine 10 further includes a control device. The control device includes an interaction component 610 and a control module. The control module is connected to the interaction component 610, the ingredient device 300 and the conveyance device 400 by means of signals. The interaction component 610 is moveably connected to the discharge bracket 210, wherein the position of the interaction component 610 is adjustable relative to the discharge bracket 210. The interaction component 610 includes at least one of a display-touch integrated screen 611 and a scanner 612.

Referring to FIG. 3, when using the interaction component 610 of the present embodiment, the display-touch integrated screen 611 can be used for displaying and for a user to input control commands, and the scanner 612 can be used for scanning a RQ code shown by the user, including but not limited to payment codes, verification codes, etc. Of course, in some embodiments, the display-touch integrated screen 611 may be cancelled, and a screen with only display function is employed. No further description is needed here.

In particular, the control module includes but not limited to an industrial personal computer, a PLC, a singlechip and the like control modules, which is not limited herein. The control device 600 further includes any one or more of an air switch, a weighing sensor transmission module, a step driver module, a switch power supply, a fuse box, a temperature control module, an electronic thermostat and a router connected to the control module electrically or by means of signals. The air switch is configured to protect circuits of the beverage preparation machine 10. The weighing sensor transmission module is configured to acquire a signal of a weighing sensor and convert it into a weight signal. Of course, when the ingredient device 300 is provided with a weighing assembly 330 configured to acquire ingredients, the weighing sensor transmission module is connected to the weighing assembly 330 and the control module by means of signals respectively. The step driver module is configured to control a liquid pump 410 in the conveyance device 400 to convey a liquid or control a solenoid valve 420 to turn on and off the pipeline. The fuse box is configured to protect power supply circuits of the beverage preparation machine 10. The temperature control module and the electronic thermostat are configured to control a pipeline temperature of the conveyance device 400, or to control an internal temperature of the frame structure 100 when the beverage preparation machine 10 is provided with a refrigeration component 150. The router is configured to transmit data.

Further, referring to FIG. 5, the discharge device 200 further includes an adjustment structure. The adjustment structure includes an adjustment fixing bracket 231 and an adjustment bracket 232. The discharge bracket 210 has an outer wall formed with an adjustment groove 211. The adjustment fixing bracket 231 is arranged inside the discharge bracket 210 and is connected to the discharge bracket 210. The adjustment bracket 232 is connected to the adjustment fixing bracket 231 and is adjustable relative to the adjustment fixing bracket 231. The adjustment bracket 232 projects at least in part out of the discharge bracket 210 from the adjustment groove 211. The interaction component 610 is connected to the adjustment bracket 232 and positioned outside the discharge bracket 210.

In the present embodiment, the adjustment fixing bracket 231 and the adjustment bracket 232 are rotatably connected. By means of the adjustment structure connected to the interaction component 610, a user can rotate the interaction component 610 while using it, achieving a good use effect.

Referring to FIG. 1, in one embodiment, the control device further includes a precise scale 620 arranged on the frame structure 100. The precise scale 620 is connected to the control module by means of a signal.

When using the beverage preparation machine 10 of the present embodiment, the preparation of the beverage preparation machine 10 can be calibrated by means of the communication between the precise scale 620 and the control module before the beverage preparation machine 10 is launched. Of course, during the usage process, it is not necessary to perform calibration for each time of preparation. For example, when a new store is started, or when the beverage preparation machine 10 is launched, or when the discharge amount of the material is found incorrect, the arranged precise scale 620 can be employed to weigh the material, where an error can be calculated out by means of the control module and a calibration is performed. The operation is simple and of high efficiency.

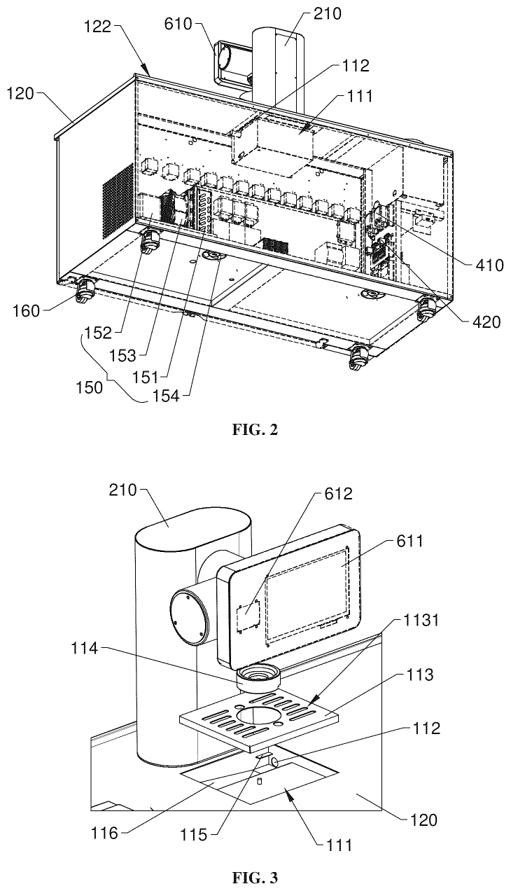

Further, referring to FIG. 2 and FIG. 3, the beverage preparation machine 10 further includes a liquid receiving assembly arranged below the discharge nozzle 221. The liquid receiving assembly includes a liquid receiving cavity 111, a liquid discharge pipe 112 and a liquid receiving plate 113. The liquid receiving plate 113 covers an opening of the liquid receiving cavity 111. The liquid discharge pipe 112 is connected to the liquid receiving cavity 111 and is positioned at least in part at a bottom of the liquid receiving cavity 111. The liquid receiving plate 113 is configured to bear a beverage container; and the liquid receiving plate 113 is formed with at least one liquid receiving hole 1131 therethrough. An orthographic projection of the beverage container (that is, beverage cup 20) on the liquid receiving plate 113 is overlapped at least in part with the liquid receiving hole 1131.

In the present embodiment, the beverage cup 20 is placed below the discharge nozzle 221, that is, above the liquid receiving assembly. When the preparation of beverage is completed and the beverage cup 20 is removed, the discharge nozzle 221 may still have some droplets to fall off. Herein, with the liquid receiving cavity 111 arranged to fit with the discharge device 200, the droplets falling off the discharge device 200 can be recovered, avoiding the occurrence of contamination and avoiding the liquid sticking on the frame structure 100 to deteriorate. By arranging the liquid receiving plate 113 that is larger than the beverage cup 20 in area to bear the beverage cup 20, the beverage cup 20 can be placed stably and avoid tipping over.

In one embodiment, the liquid receiving assembly further includes a liquid receiving seat 114 detachably connected to the liquid receiving plate 113. The liquid receiving seat 114 has formed therein a funnel shaped liquid outlet hole communicated with the liquid receiving cavity 111.

With the above arrangement, an orthographic projection of an opening of the liquid receiving seat 114 on the discharge assembly 220 can cover the plurality of discharge nozzles 221. When the beverage cup 20 is removed, the droplets falling from the plurality of discharge nozzles 221 can be guided by the liquid receiving seat 114 into the liquid receiving cavity 111. Meanwhile, the liquid receiving seat 114 arranged below the discharge nozzles 221 can also guarantee the stable placement of the beverage cup 20.

Further, the liquid receiving assembly further includes a liquid guide plate 116. One end of the liquid guide plate 116 is connected to an inner wall of the liquid receiving cavity 111 while another end thereof is inclined downward. And/or the liquid receiving assembly further includes a positioning projection part 115. The positioning projection part 115 is arranged on the inner wall of the liquid receiving cavity 111 in a projecting manner and is configured to abut against a bottom of the liquid receiving plate 113.

In the present embodiment, with the liquid guide plate 116 arranged inside the liquid receiving cavity 111, when a liquid flows through the liquid receiving hole 1131 or the liquid receiving seat 114 into the liquid receiving cavity 111, the liquid guide plate 116 can guide the liquid into the liquid discharge pipe 112 to discharge, avoiding the liquid accumulating inside the liquid receiving cavity 111 to bread bacteria, and thus guaranteeing the food safety of the beverage preparation machine 10.

Referring to FIG. 1, in one embodiment, the opening of the liquid receiving cavity 111 is formed on a top surface of the frame structure 100. A top of the frame structure 100 is further provided with a flange part 122. The flange part 122 is arranged on the top surface and is positioned on at least one side edge of the top surface.

When using the beverage preparation machine 10 of the present embodiment, the beverage cup 20 can be placed below the discharge nozzle 221, where the liquid receiving assembly bears a bottom of the beverage cup 20.

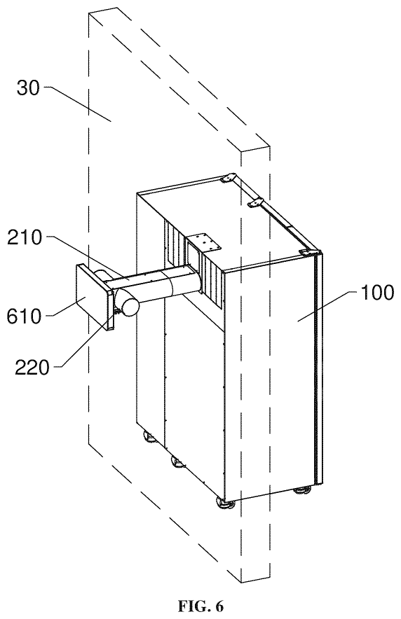

Referring to FIG. 6, in another embodiment, the discharge bracket 210 is connected to the frame structure 100 and projects outward from the frame structure 100. The discharge assembly 220 is connected to one end of the discharge bracket 210 away from the frame structure 100. Herein, the discharge bracket 210 penetrates through an external wall. The frame structure 100 and the discharge assembly 220 are positioned on two opposite sides of the wall respectively.

With the above arrangement, the whole structure of the frame structure 100 can be arranged on an inner side of a wall 30, and only the discharge bracket 210 projects out of the wall. When using the beverage preparation machine 10 of the present embodiment, a user can directly send a preparation command to the control module by means of the interaction component 610, then the control module can control the discharge device 200 to output a beverage specified by the user. In the present embodiment, a placement platform can be arranged on one side of the wall 30 away from the frame structure 100, wherein the placement platform is positioned below the discharge device 200. A user can place the beverage cup 20 on the placement platform to receive the beverage output from the discharge nozzle 221; or, the user can hold the beverage cup 20 in hand and position the beverage cup below the discharge nozzle 221, which is not limited here.

Further, the frame structure 100 includes a cabinet body 120, a cabinet door 130 and a separation plate 140. The cabinet door 130 is moveably connected to the cabinet body 120 to form an accommodation cavity. The separation plate 140 is arranged inside the accommodation cavity and separates the accommodation cavity into a first cavity 1211 and a second cavity 1212. The ingredient container 310 includes a material barrel 311, a syrup barrel 312 and a drinking water tank 320. The material barrel 311 is housed inside the first cavity 1211. The frame structure 100 further includes a refrigeration component 150. The refrigeration component 150 is configured to refrigerate the first cavity 1211. The syrup barrel 312 and the drinking water tank 320 are arranged inside the second cavity 1212, and the drinking water tank 320 is connected to the conveyance device 400 through a pipeline.

In the present embodiment, the material barrel 311 can be configured to store materials needing refrigeration. The syrup barrel 312 can be configured to store materials needing heating. By means of the separation plate 140, the accommodation cavity is separated into the first cavity 1211 and the second cavity 1212 that have different storage conditions, whereby the beverage preparation machine 10 can meet preparation requirements of different beverages.

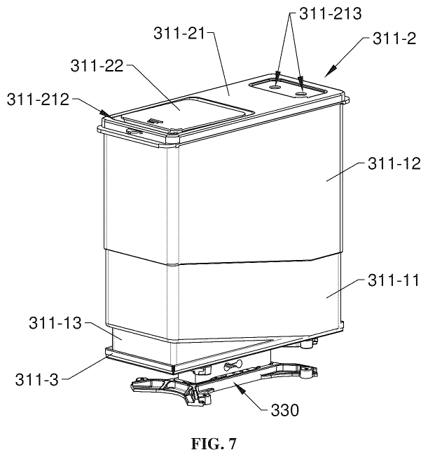

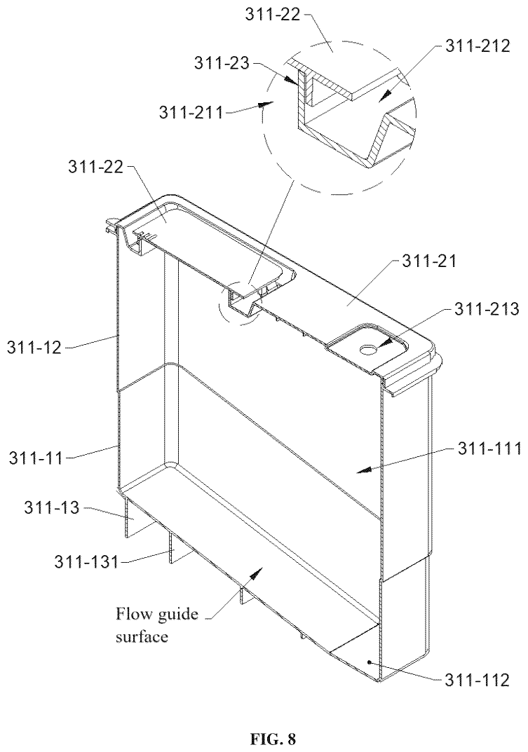

Referring to FIG. 7 to FIG. 8, in one embodiment, the material barrel 311 includes a barrel body 311-1 having a material storage cavity 311-111 formed therein. The barrel body 311-1 includes a load-bearing part 311-11 and at least one connection part 311-12. The connection part 311-12 is connected to a top of the load-bearing part 311-11 and forms the material storage cavity 311-111 with the load-bearing part 311-11. Along the direction from the connection part 311-12 toward the load-bearing part 311-11, the connection part 311-12 has a greater cross section than the load-bearing part 311-11. The material storage cavity 311-111 has a bottom provided with a liquid storage position 311-112, and a bottom surface of the material storage cavity 311-111 is inclined toward the liquid storage position 311-112. The liquid storage position 311-112 is located at least in part at a lowest point of the material storage cavity 311-111.

In the material barrel 311 of the present embodiment, with the liquid storage position 311-112 arranged at the lowest point of the bottom surface of the material storage cavity 311-111, when there is less material in the material barrel 311, the material can flow toward the material storage position to store under the guidance of the bottom surface of the material storage cavity 311-111. The external conveyance device 400 can be connected to the material storage position through a pipeline to convey the material, thereby avoiding the material being left over inside the material barrel 311 to cause waste and thus achieving a good use effect. Meanwhile, by arranging the connection part 311-12 to fit with the load-bearing part, the overall strength of the material barrel 311 can be improved. Further, since the cross section of the material barrel 311 decreases gradually in the gravity direction, the flowing of the material can be guided, whereby the material can better flow to the material storage position.

In one embodiment, there are multiple connection parts 311-12 that are connected in turn. The connection part 311-12 located at a lowest side is connected to the load-bearing part 311-11. The connection part 311-12 has an edge inclined at least in part toward the load-bearing part 311-11, wherein the edge is arranged around the load-bearing part 311-11.

It is understandable that by arranging multiple connection parts 311-12 to connect to one another and connect to the load-bearing part 311-11, the total capacity of the material barrel 311 can be improved. In addition, by means of the connection between two adjacent connection parts 311-12 or between the connection part 311-12 and the load-bearing part 311-11, a reinforced step structure can be formed on a lateral edge of the material barrel 311, whereby improving the overall strength of the material barrel 311.

In particular, referring to FIG. 7 and FIG. 8, the barrel body 311-1 further includes a support part 311-13. The support part 311-13 is arranged at a bottom of the load-bearing part 311-11, and the support part 311-13 is flush with an external bottom surface of the material storage position.

In the present embodiment, by arranging the bottom surface of the material storage cavity 311-111 as an inclined flow guide surface, the material inside the material storage cavity 311-111 will always flow to the liquid storage position 311-112 at the lowest position inside the material storage cavity 311-111 under the guidance of the flow guide surface, where one end of the pipeline of the external conveyance device 400 is aligned to the liquid storage position 311-112. Compared to conventional material storage boxes, the residual amount of material inside the material storage cavity 311-111 can be reduced, thereby reducing the occurrence of material waste. Since the arranged flow guide surface causes an external bottom surface of the material barrel 311 to be inclined, a support part 311-13 is arranged on the external bottom surface of the material barrel 311. The support part 311-13 can be flush with an external bottom surface of the liquid storage position 311-112, whereby the bottom surface of the material barrel 311 is of a flat structure that can be stably placed on a tabletop, achieving a good use effect.

Further, the support part 311-13 and a bottom surface of the load-bearing part 311-11 form a cavity therebetween, wherein inside the cavity are provided a reinforcement rib 311-131 connected to at least two inner walls of the cavity respectively.

With the above arrangement, an external wall of the reinforcement rib 311-131 can be connected at least to an inner wall of the support part 311-13 and a bottom surface of the barrel body 311-1, whereby improving the strength of the support part 311-13 and thus increasing the overall strength of the material barrel 311 and improving the durability and placement stability of the material barrel 311.

In particular, referring to FIG. 7 and FIG. 8, the material barrel 311 further includes a barrel cover 311-2 detachably connected to the barrel body 311-1. The barrel cover 311-2 includes a cover main body 311-21 and a moveable cover body 311-22. The cover main body 311-21 is formed with a material feeding hole 311-211. The moveable cover body 311-22 is moveably connected to the cover main body 311-21 and covers the material feeding hole 311-211. The barrel cover 311-2 further includes an extension part 311-23. The extension part 311-23 surrounds an opening of the material feeding hole 311-211 and extends toward one side away from the material storage cavity 311-111. The extension part 311-23 and the cover main body 311-21 form a liquid receiving groove 311-212. When the moveable cover body 311-22 covers the material feeding hole 311-211, the moveable cover body 311-22 extends at least in part toward the liquid receiving groove 311-212.

When using the material barrel 311 of the present embodiment, overturn the moveable cover body 311-22 to open the material feeding hole 311-211, and then a user can put materials into the material storage cavity 311-111 via the material feeding hole 311-211. By arranging the extension part 311-23 to form the liquid receiving groove 311-212 with the cover main body 311-21, when there is material leaking, the material can be collected by means of the liquid receiving groove 311-212, whereby avoiding material overflow and achieving a good use effect.

Furthermore, through the detachable connection, the barrel body 311-1 and the barrel cover 311-2 can be processed separately and assembled conveniently, thereby reducing the cost of production. Meanwhile, they two can be separated to add materials into the material storage cavity 311-111.

In one embodiment, there are multiple material barrels 311. The liquid pump 410 includes a peristaltic pump and a circulation pump. The peristaltic pump is connected to a solenoid valve 420 and the material barrel 311 respectively. The circulation pump has an input end and an output end connected to at least one material barrel 311 through connection holes 311-213 respectively and is configured to convey the materials inside the material barrel 311 along the input end, the output end and the material barrel 311.

In the present embodiment, the circulation pump can be connected to the material barrel 311 that stores, for example, materials having particles, precipitates and the like. During the process of usage, the circulation pump can drive the materials inside the material barrel 311 to circularly flow, preventing the materials inside the material barrel 311 from solidification or non-uniform particles/precipitates, whereby guaranteeing the efficiency of conveyance of the conveyance device 400 and the uniformity of the material particles/precipitates and thus improving the quality of beverage preparation of the beverage preparation machine 10.

Further, the beverage preparation machine 10 further includes a cleaning device 500. The cleaning device 500 is detachably connected to the beverage pipeline of the conveyance device 400 and is configured to clean the beverage pipeline.

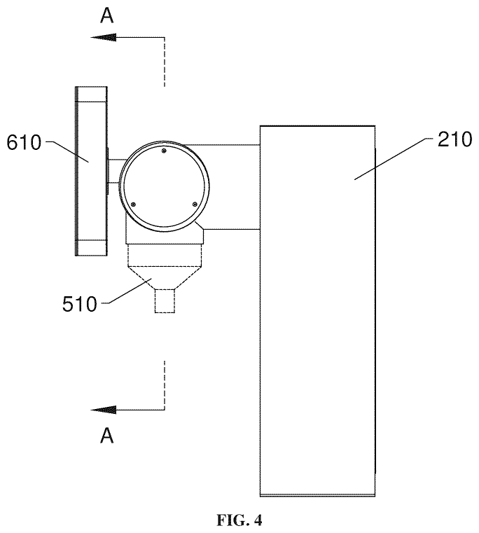

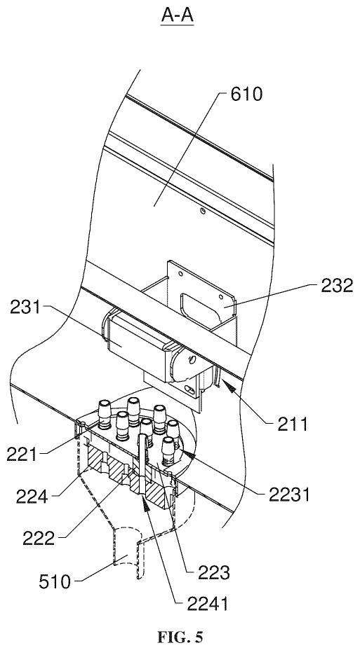

Referring to FIG. 4 and FIG. 5, in one embodiment, the cleaning device 500 further includes a cleaning flow-guide shade 510. The cleaning flow guide shade 510 is detachably connected to the discharge bracket 210 and covers the plurality of discharge holes 2241.

In particular, in the present embodiment, the discharge device 200 further includes a discharge bracket 210 connected to the frame structure 100, wherein the discharge holes 2241 are arranged on one side of the discharge bracket 210 away from the frame structure 100. The beverage pipeline is housed in the discharge bracket 210 and is connected to the discharge holes 2241, wherein the cleaning flow guide shade 510 is detachably connected to the discharge bracket 210.

In the present embodiment, by arranging the cleaning flow guide shade 510 to fit with the discharge device 200, when it is needed to clean the beverage preparation machine 10, the cleaning flow guide shade 510 is connected to the discharge bracket 210 and meanwhile covers the outlets of the discharge holes 2241. The cleaning flow guide shade 510 is roughly in a funnel shape, wherein the plurality of discharge holes 2241 are all located inside the funnel opening of the cleaning flow guide shade 510. When the plurality of discharge holes 2241 all output liquids, the cleaning flow guide shade 510 can guide centrally the liquids output by the plurality of discharge holes 2241, whereby preventing the cleaning liquids output by the discharge holes 2241 overflowing and thus achieving a good use effect. When the cleaning is finished, the cleaning flow guide shade 510 is removed from the discharge bracket 210, and then a beverage can be output through the discharge device 200.

Referring to FIG. 9 to FIG. 11, in one embodiment, the cleaning device 500 includes a cleaning interface 520, a cleaning liquid pipe and a cleaning pump 530. The cleaning interface 520 is configured to input an external cleaning material. The cleaning liquid pipe is detachably connected to the external beverage pipeline. The cleaning pump 530 is connected to the cleaning interface 520 and the cleaning liquid pipe respectively. The cleaning pump 530 is configured to output the cleaning material from the cleaning liquid pipe. Herein, there are multiple cleaning liquid pipes and multiple cleaning pumps 530. An inlet of the cleaning liquid pipe is connected to the cleaning pump 530, and outlets of the multiple cleaning liquid pipes are connected to the beverage pipeline together.

When cleaning the beverage pipeline using the cleaning device 500 of the present embodiment, the cleaning liquid pipe is connected to the beverage pipeline, the cleaning interface is connected to a cleaning material, and then the cleaning material is conveyed into the beverage pipeline by means of the arranged cleaning pump 530 to perform cleaning, where no extra component needs to be detached, the operation is convenient and the cleaning effect is good.

In particular, in the present embodiment, the cleaning liquid pipe preferably selects a food-grade silicone hose, whereby the cleaning liquid pipe can be bent and twisted during an arrangement process, the difficulty of arrangement is greatly reduced and the effect of application is good.

Further, the cleaning device 500 further includes an all-in-one interface. The all-in-one interface includes multiple inlets and one outlet. The multiple cleaning liquid pipes are connected to the multiple inlets of the all-in-one interface respectively, and the outlet of the all-in-one interface is detachably connected to the beverage pipeline.

With the above arrangement, when the multiple cleaning liquid pipes convey a detergent, hot water and drinking water respectively, they can be connected to the beverage pipeline to be cleaned by means of the all-in-one interface, wherein the multiple cleaning liquid pipes no longer need to be connected to the beverage pipeline respectively. When the all-in-one interface is connected to the beverage pipeline, the cleaning pump 530 can drive multiple cleaning materials into the beverage pipeline in sequence or simultaneously through the all-in-one interface along the multiple cleaning liquid pipes respectively, thereby performing cleaning. The operation is convenient and the cleaning efficiency is improved.

In one embodiment, the all-in-one interface is connected to the beverage pipeline respectively by means of a quick release interface.

In the present embodiment, by arranging a quick release interface to connect to the beverage pipeline and the all-in-one interface respectively, when the cleaning is completed, the all-in-one interface can be separated from the quick release interface, after which the quick release interface can seal the connection position between the beverage pipeline and the all-in-one interface, avoiding the occurrence of leakage. The all-in-one interface can be connected to the beverage pipeline quickly by means of the quick release interface, whereby achieving convenient usage.

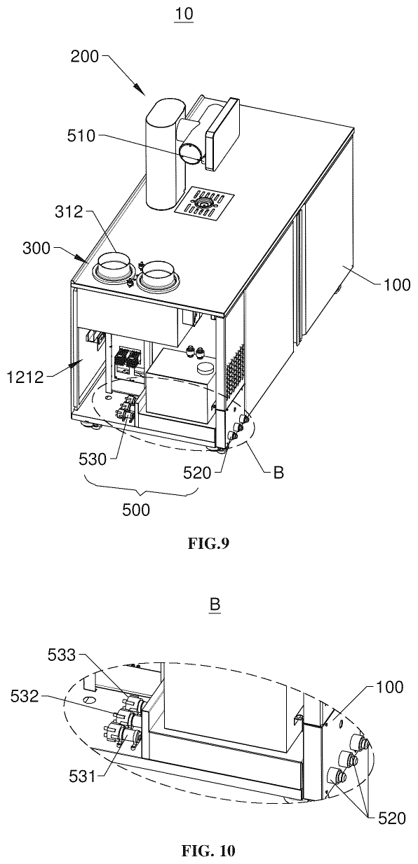

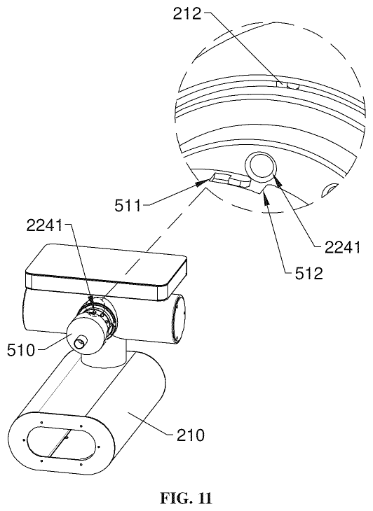

In particular, referring to FIG. 10, there are three cleaning pumps 530, respectively being a first cleaning pump 531, a second cleaning pump 532 and a third cleaning pump 533. There are three cleaning interfaces 520. The three cleaning interfaces 520 are connected to the first cleaning pump 531, the second cleaning pump 532 and the third cleaning pump 533 respectively. The first cleaning pump 531 is configured to convey a detergent. The second cleaning pump 532 is configured to convey cleaning hot water. The third cleaning pump 533 is configured to convey drinking water.

When using the cleaning device 500 of the present embodiment, the first cleaning pump 531, the second cleaning pump 532 and the third cleaning pump 533 are started in turn to convey the detergent, the cleaning hot water and the drinking water into the beverage pipeline in turn for three times of cleaning. The cleaning hot water can increase the activity of the detergent, whereby to improve the cleaning effect of the detergent. When the cleaning is finished, the drinking water can wash away the detergent residue inside the beverage pipeline. Meanwhile, after the drinking water passes through the beverage pipeline, the beverage pipeline can be directly used without extra cleaning. The cleaning efficiency is improved.

In particular, there are multiple material barrels 311. The cleaning device 500 is configured to detachably connect to multiple conveyance devices 400 respectively in sequence.

With the above arrangement, when it is needed to clean the beverage preparation machine 10, the cleaning device 500 can be connected to each conveyance device 400 in sequence to clean the beverage pipeline of the conveyance device 400 in sequence, whereby achieving the cleaning function of the beverage preparation machine 10. The operation is convenient.

Referring to FIG. 11, in one embodiment, the discharge device 200 is provided with a plurality of discharge holes 2241, and the plurality of discharge holes 2241 are connected to the conveyance device 400 respectively. The cleaning device 500 further includes a cleaning flow-guide shade 510. The cleaning flow guide shade 510 is detachably connected to the discharge device 200 and covers the plurality of discharge holes 2241.

In particular, in the present embodiment, the discharge device 200 further includes a discharge bracket 210 connected to the frame structure 100, wherein the discharge holes 2241 are arranged on one side of the discharge bracket 210 away from the frame structure 100. The beverage pipeline is housed in the discharge bracket 210 and is connected to the discharge holes 2241, wherein the cleaning flow guide shade 510 is detachably connected to the discharge bracket 210.

In the present embodiment, by arranging the cleaning flow guide shade 510 to fit with the discharge device 200, when it is needed to clean the beverage preparation machine 10, the cleaning flow guide shade 510 is connected to the discharge bracket 210 and meanwhile covers the outlets of the discharge holes 2241. The cleaning flow guide shade 510 is roughly in a funnel shape, wherein the plurality of discharge holes 2241 are all located inside the funnel opening of the cleaning flow guide shade 510. When the plurality of discharge holes 2241 all output liquids, the cleaning flow guide shade 510 can guide centrally the liquids output by the plurality of discharge holes 2241, whereby preventing the cleaning liquids output by the discharge holes 2241 overflowing and thus achieving a good use effect.

When the cleaning is finished, the cleaning flow guide shade 510 is removed from the discharge bracket 210, and then a beverage can be output through the discharge device 200.

In particular, referring to FIG. 11, the cleaning flow guide shade 510 is provided with a fixing groove part 511 and a connection groove part 512. The connection groove part 512 is connected to an edge of the cleaning flow guide shade 510 and the fixing groove part 511. The discharge device 200 is provided with a connection part 212 in a projecting manner at an edge of the discharge hole 2241. When the cleaning flow guide shade 510 is connected to the discharge device 200, the connection part 212 is inserted through the fixing groove part 511, and the connection part 212 enters inside the fixing groove part 511 from the connection groove part 512.

In the present embodiment, the fixing groove part 511 and the connection groove part 512 are connected to form an L shaped groove opening. When assembling the cleaning flow guide shade 510, the connection groove part 512 is aligned to the connection part 212 of the discharge device 200 first, then the cleaning flow guide shade 510 is rotated, where the connection part 212 moves relative to the cleaning flow guide shade 510 and into the fixing groove part 511. Since the groove opening is in an L shape, the fixing groove part 511 can hang on the connection part 212, whereby the installation position of the cleaning flow guide shade 510 is fixed by means of the connection part 212. The cleaning flow guide shade 510 is easy to detach, achieving a good use effect. When to detach the cleaning flow guide shade 510, it is only needed to move the cleaning flow guide shade 510 reversely, and no further description is needed here.

Further, the conveyance device 400 includes a liquid pump 410 and a discharge one-way valve. Two opposite ends of the liquid pump 410 are connected to the ingredient device 300 and the discharge one-way valve, while another end of the discharge one-way valve is connected to the beverage pipeline and cleaning liquid pipe respectively.

It is understandable that by arranging the discharge one-way valve to connect to the liquid pump 410 and the beverage pipeline respectively, when the cleaning device 500 is connected to the beverage pipeline, the cleaning material can be prevented from flowing back into the ingredient device 300 via the beverage pipeline, whereby avoiding contaminating the materials inside the ingredient device 300 and thus achieving a good use effect.

Further, the conveyance device 400 further includes a solenoid valve 420 connected between the discharge one-way valve and the liquid pump 410.

With the above arrangement, the solenoid valve 420 can control the on and off of the beverage pipeline, whereby controlling the beverage output of the discharge device 200.

In one embodiment, the refrigeration component 150 includes a condenser 151, a refrigerating machine 152 and a filter fan 153. The refrigeration component 150 is configured to refrigerate the ingredient containers 310 inside the accommodation cavity. The filter fan 153 is arranged between the condenser 151 and the refrigerating machine 152 and is configured to control air flowing, whereby prolonging the storage time of the ingredient device 300 or guaranteeing the freshness of the materials.

In some embodiments, the refrigeration component 150 further includes a cooling fan 154. The cooling fan 154 is connected to the frame structure 100 and is configured to control the air to flow inside and outside the accommodation cavity of the frame structure 100.

Further, referring to FIG. 2, the frame structure 100 further includes casters 160. The casters 160 are arranged at a bottom of the frame structure 100 and are configured to bear the frame structure 100 and drive the frame structure 100 to move. In some embodiments, the caster 160 may employ a universal wheel or a Fuma caster. The universal wheel can drive the frame structure 100 to move in all directions. When the frame structure 100 moves to a specified position, the Fuma caster can limit the movement of the frame structure 100.

In the description of the present disclosure, it is to be understood that the orientation or position relations indicated by such terms as “center”, “longitudinal”, “transversal”, “upper”, “lower”, “front”, “rear”, “left”, “right”, “vertical”, “horizontal”, “top”, “bottom”, “inside” and “clockwise” are based on the orientation or position relations shown in the drawings, and are merely for conveniently describing the present disclosure and simplifying the description, rather than indicating or implying that the device or element must have the specific orientation and be constructed and operated according to the specific orientation. Therefore, they should not be construed as a limitation on the present disclosure. In addition, terms such as “first”, “second”, “third”, etc. are used merely for the purpose of description, and should not be construed as indicating or implying the degrees of importance.

In the description of the embodiments of the present disclosure, unless otherwise specifically stated and defined, terms such as “interconnected”, “connected”, etc. should be interpreted expansively. For example, they may be fixed connection, also may be detachable connection, or integration; may be mechanical connection, also may be electrical connection; may be direct connection, also may be indirect connection through an intermediate. The ordinary skill in this field can understand the specific implication of the above terms in the embodiments of the present disclosure in accordance with specific conditions.

In the embodiments of the present disclosure, unless otherwise specified and limited, the phrase that the first feature is on or under the second feature may be that the first feature and the second feature are in direct contact, or the first feature and the second feature are indirect contact through an intermediate medium. In addition, the phrase that the first feature is above, over or on the second feature may be that the first feature is directly above or diagonally above the second feature, or merely indicates that the first feature has a higher horizontal height than the second feature. The phrase that the first feature is below, under or underneath the second feature may be that the first feature is directly below or diagonally below the second feature, or merely indicates that the first feature has a smaller horizontal height than the second feature.

In the description of the specification, terms such as “one embodiment”, “some embodiment”, “example”, “specific example”, or “some examples” mean that the specific features, structures, materials, or features described in combination with the embodiment or example are included in at least one embodiment or example of the embodiments of the present disclosure. In the specification, indicative expressions of the above terms do not necessarily refer to the same embodiments or examples. Moreover, the specific features, structures, materials or features described may be combined in an appropriate manner in any one or more embodiments or examples. In addition, those skilled in the art can combine the different embodiments or examples described in the specification with the features of the different embodiments or examples if no conflict is caused.

Finally, it should be noted that the above embodiments are merely to illustrate, but to limit, the technical scheme of the present disclosure. Although the present disclosure is described in detail with reference to the above embodiments, the ordinary skill in the art should understand that modifications are still possible for the technical schemes described in each above embodiment, or, partial or all technical schemes can be equivalently substituted; however, these modifications or substitutions do not get the essence of the technical scheme departed from the spirit and scope of the corresponding technical scheme in each embodiment of the present disclosure.

What is claimed is:

1. A beverage preparation machine, comprising:
a frame structure comprising an accommodation cavity formed therein;
an ingredient device comprising a plurality of ingredient containers configured to store respectively materials for preparing beverages, the ingredient device being housed inside the accommodation cavity;
a conveyance device connected to the plurality of ingredient containers respectively and configured to convey the materials; and
a discharge device comprising a discharge bracket and a discharge assembly, wherein the discharge assembly comprises a plurality of discharge nozzles, and wherein the discharge bracket has one end connected to the frame structure and projects outward from the frame structure; wherein the discharge nozzles are connected to another end of the discharge bracket and the discharge nozzles are connected to the conveyance device by means of a beverage pipeline; and wherein the beverage pipeline is housed inside the discharge bracket.

2. The beverage preparation machine according to claim 1, wherein the discharge assembly further comprises a discharge installation bracket and a discharge fixing element, wherein the discharge installation bracket is connected to one end of the discharge bracket away from the frame structure, and wherein the discharge fixing element is detachably connected to the discharge installation bracket and forms a discharge cavity with the discharge installation bracket; wherein the discharge nozzles are detachably connected to discharge installation bracket and are housed inside the discharge cavity; and wherein the discharge fixing element is further formed with a plurality of discharge holes communicated with the plurality of discharge nozzles respectively.

3. The beverage preparation machine according to claim 2, wherein the discharge assembly further comprises a discharge one-way valve housed inside the discharge cavity, the discharge one-way valve being connected to the discharge nozzle and the discharge hole respectively, and the discharge one-way valve being configured to convey a beverage along the direction from the discharge nozzle toward the discharge hole.

4. The beverage preparation machine according to claim 1, wherein the beverage preparation machine further comprises a control device, the control device comprising an interaction component and a control module, wherein the control module is connected to the interaction component, the ingredient device and the conveyance device by means of signals, and wherein the interaction component is moveably connected to the discharge bracket, the position of the interaction component being adjustable relative to the discharge bracket; and wherein the interaction component comprises at least one of a display-touch integrated screen and a scanner.

5. The beverage preparation machine according to claim 4, wherein the discharge device further comprises an adjustment structure, the adjustment structure comprising an adjustment fixing bracket and an adjustment bracket, wherein the discharge bracket has an outer wall formed with an adjustment groove; wherein the adjustment fixing bracket is arranged inside the discharge bracket and is connected to the discharge bracket; wherein the adjustment bracket is connected to the adjustment fixing bracket and is adjustable relative to the adjustment fixing bracket, the adjustment bracket projecting at least in part out of the discharge bracket from the adjustment groove; and wherein the interaction component is connected to the adjustment bracket and positioned outside the discharge bracket; and/or wherein
the control device further comprises a precise scale arranged on the frame structure, the precise scale being connected to the control module by means of a signal.

6. The beverage preparation machine according to claim 1, wherein the beverage preparation machine further comprises a liquid receiving assembly arranged below the discharge nozzle, the liquid receiving assembly comprising a liquid receiving cavity, a liquid discharge pipe and a liquid receiving plate, wherein the liquid receiving plate covers an opening of the liquid receiving cavity, and wherein the liquid discharge pipe is connected to the liquid receiving cavity and is positioned at least in part at a bottom of the liquid receiving cavity; wherein the liquid receiving plate is configured to bear a beverage container and the liquid receiving plate is formed with at least one liquid receiving hole therethrough; and wherein an orthographic projection of the beverage container on the liquid receiving plate is overlapped at least in part with the liquid receiving hole.

7. The beverage preparation machine according to claim 6, wherein the liquid receiving assembly further comprises a liquid receiving seat detachably connected to the liquid receiving plate, the liquid receiving seat having formed therein a funnel shaped liquid outlet hole communicated with the liquid receiving cavity.

8. The beverage preparation machine according to claim 6, wherein the liquid receiving assembly further comprises a liquid guide plate, one end of the liquid guide plate being connected to an inner wall of the liquid receiving cavity while another end thereof being inclined downward; and/or wherein the liquid receiving assembly further comprises a positioning projection part, the positioning projection part being arranged on the inner wall of the liquid receiving cavity in a projecting manner and being configured to abut against a bottom of the liquid receiving plate.

9. The beverage preparation machine according to any one of claims 6 to 8, wherein the opening of the liquid receiving cavity is formed on a top surface of the frame structure; and wherein a top of the frame structure is further provided with a flange part, the flange part being arranged on the top surface and being positioned on at least one side edge of the top surface.

10. The beverage preparation machine according to any one of claims 1 to 8, wherein the discharge bracket is connected to the frame structure and projects outward from the frame structure, and wherein the discharge assembly is connected to one end of the discharge bracket away from the frame structure; and wherein the discharge bracket penetrates through an external wall, the frame structure and the discharge assembly being positioned on two opposite sides of the wall respectively.
